(19) United States
(12) Patent Application Publication
(10) Pub. No.: US 2026/0265859 A1
(43) Pub. Date: Sep. 10, 2026

(54) METHOD FOR THE RECOVERY OF METALS FROM E-WASTE

(71) Applicant: RENEWABLE METALS PTY LTD, Sydney, NSW (AU)

(72) Inventor: Mark Daniel URBANI, Wattle Grove, Western Australia (AU)

(21) Appl. No.: 19/473,653

(22) PCT Filed: Mar. 27, 2024
(86) PCT No.: PCT/AU2024/050285

§ 371 Date: Oct. 8, 2025

(30) Foreign Application Priority Data
Apr. 11, 2023 (AU) 2023901052
Apr. 11, 2023 (AU) 2023901053
Apr. 11, 2023 (AU) 2023901054
Aug. 16, 2023 (WO) PCT/AU2023/050771

(51) Int. Cl. C22B 7/00; C01D 15/06; C01G 45/024; C01G 45/026; C01G 45/028; C22B 3/00; C22B 3/24; C22B 3/44; C22B 15/00; C22B 26/12; C22B 47/00; H01M 10/54

(52) U.S. Cl. CPC C22B 7/008; C01D 15/06; C01G 45/024; C01G 45/026; C01G 45/028; C22B 3/24; C22B 3/44; C22B 15/0086; C22B 23/0461; C22B 26/12; C22B 47/00; H01M 10/54

(57) ABSTRACT

Disclosed herein is a method of recovering metals from a leachate of an alkaline leach of electronic waste, the leachate including Cu, Li, and Mn ions, the method including recovering Mn from the leachate; after the step of recovering Mn from the leachate, recovering Cu from the leachate; and after the step of recovering Cu from the leachate, recovering Li from the leachate.

### FIELD

The invention generally relates to methods for recovering lithium and optionally other transition metals from waste electronic material that comprises at least copper and one or more lithium salts, and in particular, where the waste electronic material is waste lithium-ion batteries.

### BACKGROUND

The volume of waste electronics, and in particular, rechargeable Li-ion batteries used worldwide has been growing rapidly in recent years and is set for further expansion with the emerging markets of electric vehicles and mass electric power storage. As the demand for electronic devices, and in particular those using Li-ion batteries increases, so does the demand for the metal/metal oxide components that are used in these devices. The rapid increase in demand for some of these metals, such as cobalt, has put pressure on the sustainable supply of such resources. This has caused the cost of such metals to rapidly increase.

There has been little interest in developing processes for the recovery and recycling of the various components in modern electronic devices and components thereof such as batteries. In the case of batteries, this is mainly due to the relatively low volume of Li-ion batteries available for recycling and the relatively high cost of the typical pyrometallurgical and hydrometallurgical processes by which the recovery is achieved. As the demand for Li-ion batteries continues to increase, so does the volume of spent Li-ion batteries that are available for recycling. There is a need for low-cost, efficient recycling processes, particularly in respect of the more complex metal/metal oxide components. Whilst the discussion below is primarily in respect of Li-ion batteries, it is applicable to a range of electronic devices since these likewise incorporate a range of different metal compounds.

The composition of Li-ion batteries has evolved considerably over recent times. Whilst some battery recycling processes have been developed, these have primarily been limited to the recovery of certain specific metals from a certain specific type of battery or feed source. For example, early batteries were predominantly lithium-cobalt and the focus of the recovery methods was on recovering cobalt. As lithium demand increased, the recovery methods shifted to the recovery of both cobalt and lithium. As battery technologies underwent further developments, the cathodes incorporated other metals, such as manganese, nickel, aluminium, iron and phosphorus. The methods used to recover lithium and cobalt are not suited for the recovery of other metals, nor are they well suited for different battery chemistries.

The uptake in the usage of Li-ion batteries will increase the volume of spent Li-ion batteries available for recycling. However, the supply of spent Li-ion batteries will include many different types of batteries. The suitability of recovery methods to only a single battery type presents a significant problem to the commercialisation of such processes. Specifically, such methods require one or more sorting steps and pre-processing steps. Given this, there is a need for the development of a process for the recovery of a range of metals from a range of different Li-ion battery types.

Most developments in battery recycling processing involve dissolution of the metal components in acidic media. This is a non-selective leaching process during which most metals contained in a battery are dissolved. Batteries contain various non-valuable metals, such as iron, manganese and aluminium, at an appreciable amount. Some batteries may also include phosphorous. Acid consumption is high if these non-valuable metals and phosphorous are not removed prior to leaching. Consequently, pretreatment processes are required to separate iron, aluminium from valuable metal components such as cobalt, nickel, copper and lithium. In so doing, the recovery of these valuable metals diminishes as the separations achieved in these pretreatment processes are not 100% efficient.

It is desirable to provide a method for the recovery of metals, and in particular lithium, from waste electronic devices such as batteries.

It is an object of the invention to address one or more shortcoming of the prior art and/or provide a useful alternative.

### SUMMARY OF INVENTION

In a first aspect of the invention, there is provided a method of recovering metals from a leachate of an alkaline leach of electronic waste, the leachate comprising Cu, Li, and Mn ions, the method comprising:
recovering Mn from the leachate;
after the step of recovering Mn from the leachate, recovering Cu from the leachate; and
after the step of recovering Cu from the leachate, recovering Li from the leachate.

In one embodiment, the leachate additionally comprises Co ions, and after the step of recovering Cu from the leachate and prior to the step of recovering Li from the leachate, the method further comprises recovering Co from the leachate.

In a second aspect of the invention, there is provided a method of recovering metals from a leachate of an alkaline leach of electronic waste, the leachate comprising Cu, Li, Ni, and Mn ions, the method comprising:
recovering Mn from the leachate;
after the step of recovering Mn from the leachate, recovering Cu and Ni from the leachate; and
after the step of recovering Cu and Ni from the leachate, recovering Li from the leachate.

In an embodiment the leachate additionally comprises Co ions, and after the step of recovering Cu and Ni from the leachate and prior to the step of recovering Li from the leachate, the method further comprises recovering Co from the leachate.

In one embodiment, Cu and Ni are recovered contemporaneously. In a first alternative embodiment Cu is recovered prior to Ni. In a second alternative embodiment Ni is recovered prior to Cu.

In an embodiment of the first or second aspects (and/or embodiments thereof), the leachate is substantially free of Fe and/or Al ions. Preferably, Fe and/or Al are each present in the leachate at a concentration of 100 mg/L or less. More preferably, Fe and/or Al are each present in the leachate at a concentration of 80 mg/L or less. Most preferably, Fe and/or Al are each present in the leachate each at a concentration of 60 mg/L or less.

In an embodiment of the first or second aspects (and/or embodiments thereof), prior to the step of recovering Mn, the leachate comprises the Cu, Li, and Mn ions in the form of Cu²⁺, Mn²⁺, and Li⁺. In forms in which Co and/or Ni are present, prior to the step of recovering Mn, the leachate comprises Co and/or Ni in the form of Co²⁺ and Ni²⁺.

In an embodiment of the first or second aspects (and/or embodiments thereof), the method further comprises leaching the electronic waste with an alkaline leach solution comprising at least ammonium sulfate and ammonia to provide the leachate.

In one form of the above embodiment, the electronic waste comprises, consists of, or consists essentially of one or more types of lithium-ion batteries, such as lithium nickel manganese cobalt oxide (NMC) batteries. Preferably the batteries are in the form of lithium-ion battery shreds. In alternative embodiments, the electronic waste comprises a mixture of one or more types of lithium-ion batteries and other electronic waste, such as printed circuit boards and the like.

In one form of the above embodiment, the electronic waste comprises, consists of, or consists essentially of one or more types of lithium compounds selected from the group comprising comprises LiNi_{w}CoₓAl_{y}Mn_{z}O₂ wherein w+x+y+z=1, and/or LiNiₓMn_{y}Co_{1-x-y}O₂ where 0≤x+y≤1.

In an embodiment of the first or second aspects (and/or embodiments thereof), the step of recovering Mn from the leachate comprises:
treating the leachate with an oxidant to form a Mn precipitate; and
separating the Mn precipitate from the leachate.

In one form of the above embodiment, the oxidant is selected from the group consisting of air, hydrogen peroxide, and/or hypochlorite.

In one form of the above embodiment, the Mn precipitate is a manganese oxide selected from the group consisting of Mn₂O₃, Mn₃O₄ and/or MnO₂. It is preferred that the Mn precipitate is not, and/or does not comprise, Mn(OH)₂.

In an embodiment of the first or second aspects (and embodiments thereof), the step of recovering Li from the leachate comprises:
crystallising ammonium lithium sulfate from the leachate, and
separating crystallised ammonium lithium sulfate from the leachate.

In one form of the above embodiment, the method further comprises thermally decomposing the crystallised ammonium lithium sulfate to form a gas comprising ammonia and sulfur oxides, and solid lithium sulfate.

In an embodiment of the first or second aspects (and/or embodiments thereof) prior to the step of recovering Li from the leachate, the leachate is treated such that the leachate is an ammonia-, Cu-, Ni-, Co-, Mn-lean leachate and/or the leachate comprises substantially no ammonia, Al, Cu, Fe, Ni, Co, or Mn.

In an embodiment of the first or second aspects (and/or embodiments thereof) prior to the step of recovering Li from the leachate, the leachate is treated such that the leachate comprises ammonia-, Cu-, Ni-, Co-, Mn each at a concentration of 100 mg/L or less. Preferably, each at a concentration of 80 mg/L or less. Most preferably, each at a concentration of 60 mg/L or less.

In an embodiment of the first or second aspects (and embodiments thereof) the step of recovering Cu ions from the leachate uses a solvent extraction process, the solvent extraction process comprising:
contacting the leachate with an extractant to adsorb Cu ions into the extractant to form a Cu-loaded extractant, and
separating the Cu-loaded extractant from the leachate.

In one form of the above embodiment, the method further comprises stripping the Cu ions from the Cu-loaded extractant using a stripping agent, such as sulfuric acid.

In an embodiment of the second aspect (and/or embodiments thereof) the step of recovering Cu and Ni ions from the leachate comprises contemporaneously recovering Cu and Ni ions using a solvent extraction process, the solvent extraction process comprising:
contacting the leachate with an extractant to adsorb Cu and Ni ions into the extractant to form a Cu-, Ni-loaded extractant, and
separating the Cu-, Ni-loaded extractant from the leachate.

In one form of the above embodiment, the method further comprises stripping the Cu and Ni ions from the Cu-, Ni-loaded extractant using a stripping agent, such as sulfuric acid, wherein Ni ions are selectively recovered at a first stripping agent concentration and Cu ions are subsequently recovered at a second stripping agent concentration, the first stripping agent concentration being less than the second stripping agent concentration.

In an embodiment of the first aspect (and/or embodiments thereof), prior to the step of recovering Cu the method further comprises treating the leachate with an oxidant to oxidise Co ions from Co²⁺ to Co³⁺. Preferably, the oxidant is selected from the group consisting of air, hydrogen peroxide, and/or hypochlorite.

In an embodiment of the second aspect (and/or embodiments thereof), prior to the step of recovering Cu and Ni the method further comprises treating the leachate with an oxidant to oxidise Co ions from Co²⁺ to Co3+. Preferably, the oxidant is selected from the group consisting of air, hydrogen peroxide, and/or hypochlorite.

In an embodiment of the first or second aspects (and/or embodiments thereof), the step of recovering Co from the leachate comprises:
treating the leachate with a precipitant to form a Co precipitate; and
separating the Co precipitate from the leachate.

A suitable precipitant is a sulfide, such as hydrogen sulfide. The Co precipitate (in this example, a cobalt sulfide) can then be recovered from the combined leachate using any solid-liquid separation process generally known to those skilled in the art, such as filtration.

In an embodiment of the first or second aspects (and/or embodiments thereof), the leachate comprises ammonium sulfate and/or ammonia. Preferably, the leachate comprises ammonia and ammonium sulfate in a ratio of from about 1:2 to about 1:20. In one form of this embodiment, the leachate additionally comprises ammonium chloride.

In an embodiment of the first or second aspects (and/or embodiments thereof):
the leachate has an initial pH in the range of from about 8.5 up to 10.5; and/or
during one or more or each of the recovery steps the leachate has a pH in the range of from about 8.5 to 10.5.

In an embodiment of the first or second aspects (and embodiments thereof) one of the following apply:
the leachate has a Cu:Mn ratio of from about 0.5:1 up to about 2:1; or
the leachate has a Cu:(Mn+Co) ratio of from about 0.5:1 up to about 2:1; or
the leachate has a Cu:(Mn+Ni) ratio of from about 0.5:1 up to about 2:1; or
the leachate has a Cu:(Mn+Co+Ni) ratio of from about 0.5:1 up to about 2:1.

In an embodiment, the leach solution is substantially free of added organic compounds. That is, the leach solution may comprise organic compounds which arise from the leach of electronic waste, but does not comprise further added organic compounds. By way of example, the leach solution comprises no monomers, oligomers, polymers, surfactants, organic lixiviants, organic acids, organometallic compounds and the like.

In an embodiment, the leach solution is substantially free of biological material. By way of example, the leach solution comprises no vegetable, fruit, or animal biomatter.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

As used herein, except where the context requires otherwise, the term “comprise” and variations of the term, such as “comprising”, “comprises” and “comprised”, are not intended to exclude further additives, components, integers or steps.

### BRIEF DESCRIPTION OF DRAWINGS

Further aspects of the present invention and further embodiments of the aspects described in the preceding paragraphs will become apparent from the following description, given by way of example and with reference to the accompanying drawings.

FIG. 1 is a process flow diagram illustrating the method of the invention in accordance with another embodiment thereof.

### DESCRIPTION OF EMBODIMENTS

The invention broadly relates to a method for recovering valuable metals from a leachate obtained from an alkaline leach of electronic waste (and in particular lithium-ion battery shreds). The invention is particularly applicable to the recovery of Cu, Li, and Mn from a leachate containing ions of these metals. However, also contemplated is the additional recovery of Co and Ni from a leachate that additionally comprises ions of these metals.

Generally, the metal recovery process of the invention is for the recovery of metals from an alkaline leach of electronic waste. In particular, using a leach solution comprising ammonium sulfate, and optionally ammonia and/or ammonium chloride. In the leach, elemental copper is oxidized to copper ions thus providing a source of electrons to act as a reductant and thereby produce soluble lithium ions from the lithium containing salts. Transition metals such as cobalt, manganese, and nickel that are present in the electronic waste, e.g., as a component of the lithium containing salts, or as a metal oxide and the like, are likewise reduced to soluble ions. The various soluble metals ions, and in particular, lithium can be selectively recovered as products. The ammonium sulfate can likewise be recovered and reused for further leaching.

The inventors have found that the order of metal recovery from the leachate is important in order to recover high purity products whilst minimizing operating costs. In particular, the inventors have found that in a leachate comprising Cu, Li, and Mn, it is important that the Mn is first recovered, followed by the recovery of Cu, and finally the recovery of Li.

Co and Ni are transition metals which are also present in many types of electronic waste, such as various types of lithium-ion batteries. Given this, ideally the method can be adjusted to additionally recover these metals. In the case where the leachate comprises Ni, the inventors have found that Ni can best be removed after the recovery of Mn and before, after, or at the same time as Cu. In the case where the leachate comprises Co, the inventors have found that this can best be removed after the recovery of Mn, Cu, and Ni (if present), but prior to the recovery of Li.

In more detail, the inventors have found that Mn ions can be recovered by an oxidation step of in which Mn ions are oxidized to manganese oxides such as Mn₂O₃, Mn₃O₄ and/or MnO₂ (but not MnO). Suitable oxidants include air, hydrogen peroxide, and/or hypochlorite. Air is the preferred oxidant. These manganese oxides are insoluble and therefore form a precipitate which can be separated as a high purity solid product from the leachate using standard solid-liquid separation process, as known to those skilled in the art.

If Co²⁺ ions are present in the leachate during this oxidation process, then these will be advantageously oxidised to Co³⁺ ions-which avoids Co ions being co-recovered during the recovery of Cu and Ni (if present) as discussed below. To prevent co-precipitation of CoO with the Mn, the leachate preferably contains ammonia.

Ammonia forms stable soluble sulphate complexes with Co ions and therefore prevents the precipitation of CoO whilst instead promoting the oxidation of Co²⁺ to Co³⁺ during this oxidation treatment step. Ideally, sufficient ammonia is present to provide a pH in the range of 9-10. The ammonia may be present in sufficient quantity within the leachate as a result of the original leaching process. Alternatively, or additionally, top up ammonia may be added to the leachate to provide sufficient ammonia to prevent formation of CoO.

The presence of ammonia is also beneficial where the leachate comprises Ni. The ammonia beneficially complexes with Ni to form stable soluble Ni ammonia sulphates, particularly at pH values in the range of 9-10. This aids in the selective extraction and recovery of Ni as generally discussed below.

Once Mn has been recovered from the leachate, the leachate being substantially free of Mn can then be treated for the recovery of Cu.

Cu ions can be recovered via a solvent extraction process. That is, the leachate is contacted with an extractant to recover Cu ions from the leachate and form a Cu-loaded extractant. The extractant can then be stripped with a stripping agent, such as sulfuric acid, to recover Cu such as in the form of CuSO_{4 (aq)}. If desired, Cu metal can be recovered via methods known to those skilled in the art, such as electrowinning.

It is important that the leachate is subjected to an oxidation process prior to recovery of Cu. This is for two reasons. Firstly, the oxidation process facilitates the recovery of Mn. Mn should be recovered prior to Cu and Ni, since if Mn is present in an appreciable amount during the solvent extraction of Cu and Ni, the Mn may be coextracted with the Cu and Ni, and then recovered with Ni thus contaminating the recovered Ni product and thus causing downstream issues with the purity of the resultant Ni product and/or require additional more expensive unit process steps to separate the Ni and Mn. The second reason is that if Co is present in the leachate, then this will be oxidised from Co²⁺ to Co³⁺. This likewise prevents cobalt from being recovered during solvent extraction, and thus prevents poisoning of the extractant with Co²⁺ ions.

In embodiments where the leachate additionally includes Ni ions, Ni may be recovered before, after, or with the Cu. However, it is preferred that Cu and Ni ions are recovered from the leachate together in the solvent extraction process. That is, Ni ions can be contemporaneously extracted with Cu ions via the solvent extraction process. Once extracted, the Ni ions can then be selectively stripped from the extractant with a stripping agent prior to stripping of Cu ions. It is preferred that the extractant is sulfuric acid, in which case Ni ions can be stripped at relatively lower terminal sulfuric acid concentration than Cu ions thus permitting the selective recovery of Ni and Cu ions. If desired, Cu and Ni metal can each be recovered via methods known to those skilled in the art, such as electrowinning.

After the sequential removal of Mn, followed by Cu (and Ni if present) from the leachate, the leachate can then be treated to recover Co if present. Co can be recovered from the leachate via precipitation, e.g., with sulfide. The cobalt sulfide precipitate can be separated as a high purity solid product from the leachate using standard solid-liquid separation process, as known to those skilled in the art.

The leachate, being substantially free of Co, Cu, Mn, and Ni can then be treated to recover ammonia, e.g. by steam stripping, prior to the recovery of Li.

The inventors have found that Li can be recovered in the form of ammonium lithium sulfate through crystallization, e.g., concentrating the leachate, such as by evaporating water from the leachate, to crystallise ammonium lithium sulfate. The ammonium lithium sulfate can then be recovered by solid-liquid separation (e.g., filtration, centrifugation, and the like) and then thermally decomposed to lithium sulfate crystals, ammonia gas, and sulfur oxide gases. The sulfur oxide gases can be reacted with the ammonia gas and water to regenerate ammonium sulfate if desired.

The method thus provides an effective solution for recovery of high purity Mn, Cu, and Li, and optionally Co and Ni from a leachate comprising these metal species.

The invention will be described below in relation to embodiments thereof which are intended to be illustrative in nature and should not be construed in a limiting manner.

### Exemplary Embodiment

This embodiment describes a method for the recovery of metals from a feed containing one or more lithium-ion battery types. In this particular embodiment, the feed comprises copper metal and metal oxides of at least cobalt, lithium, manganese, and nickel.

The method includes an initial leaching step in which lithium-ion battery waste (which may be blended with other sources of electronic waste) is subjected to an alkaline leach with a first leach solution comprising ammonium sulphate. In this particular embodiment, the first leach solution additionally comprises ammonia which is found to enhance the leach process as described previously. The leach is carried out at atmospheric pressure and at ambient temperatures. However, the leach may be carried out at elevated temperatures, for example, at temperatures of less than the boiling point of the leach solution.

The alkaline leach oxidises elemental copper contained in the lithium-ion batteries into soluble copper ions, and reduces or otherwise liberates nickel, cobalt, manganese and lithium ions contained in, for example nickel manganese cobalt (NMC), lithium cobalt oxide (LCO), and lithium-ion manganese oxide (LMO) batteries. Thus, the leach results in the formation of a first leachate comprising soluble ions of cobalt, copper, lithium, manganese, and nickel, and a first solid residue.

The first leachate is then separated from the first solid residue.

The first solid residue comprises low value materials such as iron and aluminium but depending on the types of lithium-ion battery waste, can also contain residual cobalt, lithium, manganese and nickel compounds. For example, where the feed comprises lithium iron phosphate (LFP) and lithium nickel cobalt aluminium oxide (NCA) batteries, some of the cobalt, lithium, and nickel is retained in the first solid residue.

The quantities of cobalt, lithium, manganese, and nickel may be in amounts sufficient that further recovery of these metals is economically viable and thus desirable. If so, the first solid residue may be subjected to a further leaching step with a second leach solution comprising ammonium sulfate and preferably ammonium chloride. The second leach is carried out at atmospheric pressure and at ambient temperature. However, as above, the second leach may be carried out at elevated temperature, such as at temperatures of less than the boiling point of the leach solution. The second leach may be an oxidative leach. That is, an oxidant such as air, hydrogen peroxide, hypochlorite and the like may be used during the leach to aid in the recovery of metals. Generally, with a feed that comprises NCA and/or NMC battery materials an oxidant is not required since cobalt, nickel, and manganese are present in sufficient quantities to provide a sufficiently high redox half-cell potential of >100 mV. However, if the redox half-cell potential was less than 100 mV, such as is typically the case with a feed of LFP battery waste, then an oxidant is useful to aid or enhance the leaching process.

The second leach provides a second leachate comprising soluble ions of cobalt, lithium, manganese, and nickel, and a second solid residue.

The second leachate is then separated from the second solid residue. As above, depending on the types of batteries present, the second solid residue may contain residual cobalt, lithium, manganese, and nickel in commercially recoverable amounts.

To further recover these metals, the second solid residue is subjected to a size separation process to classify the first solid residue into a coarse fraction and a fine fraction. The fine fraction contains >80% of the residual nickel and also contains some residual cobalt, lithium, and manganese. The fine fraction is subjected to an acid leach, such as with sulfuric acid, to provide a third leachate comprising ions of cobalt, lithium, manganese, and nickel, and a third solid residue. The third leach is carried out at atmospheric pressure and at ambient temperature. However, as above, the third leach may be carried out at elevated temperature, such as at temperatures of less than the boiling point of the leach solution.

The third leachate is then separated from the third solid residue.

It will be appreciated that in alternative embodiments, the second and/or third leach step is/are omitted.

Aluminium, iron, and phosphate are not extracted to significant amounts and are generally retained in the first, second, and/or third solid residues. Given this, the leaching process is selective for higher value metals such as copper, cobalt, lithium, manganese, and nickel.

The first, second, and third leachates may then be combined to form a combined leachate which may then be subjected to a number of steps for the selective recovery of cobalt, copper, lithium, manganese, and nickel.

To recover manganese, the combined leachate is subjected to an oxidation step in the presence of ammonia to precipitate manganese in the form of manganese oxides such as Mn₂O₃, Mn₃O₄ and/or MnO₂ (but not Mn(OH)₂). The inventors have found that where the leachate additionally comprises cobalt ions, the presence of ammonia is important to complex with the cobalt ions to retain these in the form of soluble Co³⁺ ions and prevent the formation of a CoO precipitate. The manganese oxide precipitate can then be recovered from the combined leachate using any solid-liquid separation process generally known to those skilled in the art, such as filtration.

The combined leachate can then be subjected to a solvent extraction step for the extraction of copper and/or nickel. The solvent, loaded with copper and/or nickel can then be separated from the combined leachate, with copper and/or nickel subsequently being recovered from the solvent. Copper and nickel may be recovered from the solvent via stripping with a stripping agent, such as sulfuric acid. Generally, nickel can be selectively stripped with a lower residual acid concentration than for copper, e.g., in the pH range of about 1-4 with copper being subsequently stripped by increasing the acid concentration e.g., to greater than about 50 g/L H₂SO₄. This two-stage stripping allows the copper and nickel to be selectively separated.

The combined leachate can then be subjected to further treatment to recover cobalt. In this embodiment, cobalt is recovered via a cobalt precipitation process whereby the combined leachate is treated with a sulfide, such as hydrogen sulfide gas or ammonium sulfide, to precipitate cobalt sulfide. The cobalt sulfide can then be recovered from the combined leachate using any solid-liquid separation process generally known to those skilled in the art, such as filtration.

The combined leachate, now substantially depleted of cobalt, copper, manganese, and nickel can be further treated to recover ammonia, ammonium salts, and lithium.

Ammonia is steam stripped from the leachate and the recovered ammonia is recycled and reused as a component of the first leach solution. The lithium in the leachate is generally in the form of lithium sulfate. This lithium sulfate can be crystallised with ammonium sulfate (e.g., via an evaporation process) in the form of lithium ammonium sulfate and separated from the leachate. The lithium ammonium sulfate can then be subjected to thermal treatment to decompose the lithium ammonium sulfate to a lithium sulfate solid, ammonia gas, and sulfur oxide gases. The ammonia and sulfur oxide gases can be captured and reacted together with water, such as in a wet scrubber, to form ammonium sulfate which can then be recycled to the first and/or second leaching steps.

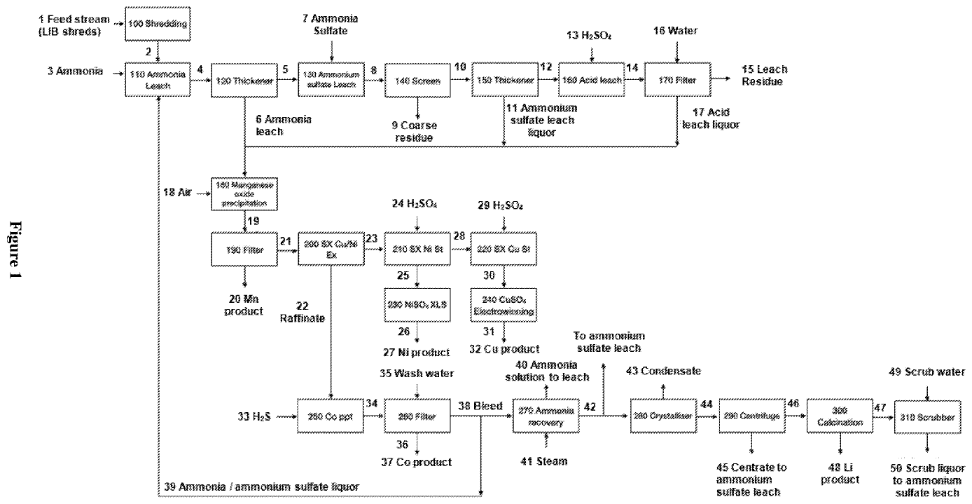

The process is described in more detail with reference to FIG. 1. FIG. 1 is a process flow diagram illustrating the method of the invention according to the embodiment generally described above.

The method of FIG. 1 describes the recovery of a nickel product 27, a copper product 32, a cobalt product 37 and a lithium product 48. In this embodiment, feed stream 1 is subjected to a pre-treatment process, for example shredding 100 to <5 mm, for example <1 mm, to render the feed stream 1 suitable for further processing. The resulting shredded feed stream 2 is then passed to an alkaline leach circuit 110, in which it is contacted with a liquor containing ammonia, ammonium sulfate with/without ammonium chloride 39, and ammonia top-up 3 and 40 to solubilise metal species. Conditions in the alkaline leach circuit 110 include about 5-10% solids, about 50° C., atmospheric pressure, about a 12-hour residence time, a pH of about 9 with ammonia about 200 g/L ammonium sulfate, and about 20 g/L ammonium chloride if present.

The resultant alkaline leached slurry 4 is subjected to a solid liquid separation step 120, such as a thickener, or number of thickeners with washing, and the ammonia leach liquor 6, is directed to the manganese oxide precipitation circuit 180.

The thickener underflow 5 is directed to an ammonium sulfate leach circuit 130, where it is contacted with a solution containing ammonium sulfate 47 and ammonium sulfate top-up 7. Conditions in the ammonium sulfate leach circuit 130 include about 5-10% solids, about 90-100° C., atmospheric pressure, about 4-12 hours residence time, about 200 g/L ammonium sulfate and 20 g/L ammonium chloride.

The ammonium sulfate leach discharge 8 is directed to a screen 140, for example of between 75-500 μm, for example about 180 μm, to separate a coarse fraction and a fine fraction of particles. The coarse fraction 9 is stored and the fine fraction 10 is directed to a thickener 150. The thickener overflow, for example ammonium sulfate leach liquor 11, is directed to a manganese oxide precipitation circuit 180.

The thickener underflow 12 is directed to an acid leach circuit 160, where it is contacted with sulfuric acid 13. The conditions for the acid leach circuit 160 included a temperature in the range of about 20 to 100° C., for example 70° C., a pH of less than about 3.5, for example a pH of about 2.5, a residence time of between about 4-12 hours, 30% solids and 98% sulfuric acid addition.

An acid leach discharge 14 is subjected to filtration 170 and the solids are washed to produce a leach residue 15, which is stored, and an acid leach liquor 17, that is directed to the manganese oxide precipitation circuit 180.

The leach liquors 6, 11 and 17 are directed to the manganese oxide precipitation circuit 180 in which air 18 is sparged into the liquor to force the precipitation of manganese oxides. A precipitation slurry 19 is subject to solid liquid separation by thickening and filtration 190. A manganese product 20 is washed and stored.

A pregnant leach liquor post manganese precipitation 21 is directed to a copper and nickel solvent extraction circuit 200 where it is contacted with a copper and nickel extractant, such as a commercially available oxime extractant, for example LIX841™ (an extractant comprising an active component of 2-hydroxy-5-nonylacetophenone oxime). Copper and nickel are loaded onto the copper extractant and a loaded extractant 23 is separated from a raffinate 22. The loaded extractant 23 is contacted with dilute sulfuric acid 24, for example 150 g/L sulfuric acid, in a nickel strip stage 210 to produce a loaded strip liquor containing nickel 25 and a nickel depleted extractant 28. The nickel depleted extractant 28 is contacted with dilute sulfuric acid liquor 29, for example 200 g/L sulfuric acid, in the copper strip stage 220 to produce a loaded strip liquor 30 containing copper. A stripped organic (not shown) is recycled (not shown) to the extraction circuit 200 to extract more copper and nickel. A nickel product 27 (ostensibly in the form of nickel sulfate) is recovered from the nickel loaded strip liquor 25 in a nickel crystallisation stage 230. A copper product 32 (ostensibly in the form of copper sulfate) is recovered from the copper loaded strip liquor 30 in a copper electrowinning stage 240.

The copper and nickel depleted raffinate 22 is directed to a cobalt recovery circuit 250 in which a precipitation reagent, for example hydrogen sulfide gas 33, is added to force the precipitation of cobalt sulfide. A resulting slurry 34 is subjected to solid liquid separation, for example by way of a thickener and filter 260 and washed with water 35 to produce a cobalt product 37.

Most of a resulting filtrate 39, which contains ammonia and ammonium sulfate, is directed to the ammonia leach circuit 110 to recover more metal. The remaining filtrate 38 is directed to an ammonia recovery circuit 270, in which steam 41 is used to strip ammonia 40. A recovered ammonia 40 is re-used in the process, specifically for example in the ammonia leach 110.

An ammonia free liquor 42 is directed to the ammonium sulfate leach 130 and also to a crystalliser 280 in which a condensate 43 is removed by forced evaporation and lithium ammonium sulfate 46 is crystallised. The crystalliser discharge is subjected to solid liquid separation using a centrifuge 290 and the centrate 45 is directed to the ammonium sulfate leach 130. The lithium ammonium sulfate 46 intermediate is subjected to calcination in a kiln 300 in which the solids, lithium sulfate 48, are collected for sale and an off-gas 47 is collected in a wet scrubber, utilising scrub water 49, to recover ammonium sulfate solution 50.

### Example 1

A total of 224 kg of battery shreds, consisting of a mixture of LFP (50%), NMC622 (20.5%), NMC811 (11%), NCA (11%) and LCO (7.7%), was processed through a pilot plant. The weighted average feed grade was 11.9% Cu, 6.45% Ni, 3.09% Co, 1.81% Li and 1.51% Mn. The pilot plant consisted of primary leaching in ammonia, ammonium sulfate, ammonium chloride liquor at 50° C. and pH 9.0, secondary leaching in ammonium sulfate, ammonium chloride liquor at 90° C., pH 5-6 and Eh>120 mV and tertiary leaching in sulfuric acid at pH 3.0-3.5 and 90° C. The three stage leach resulted in nickel, cobalt, copper, lithium and manganese extractions of 96.7, 98.4, 97.6, 97.7% and 97.5% respectively.

The leach liquors were combined and subjected to aeration to target Eh >100 mV and pH control with ammonia to target pH 10.0. The concentration of manganese in solution post oxidation averaged 10 mg/L Mn. This equates to a manganese recovery of 98.4%. The manganese product contained 39% Mn.

The liquor post manganese removal was processed through a solvent extraction plant using LIX841 as extractant. The copper and nickel extractions averaged 99.8 and 99.6% for the campaign. Excellent selectivity was achieved in the circuit. The nickel loaded strip liquor averaged 73.1 g/L Ni and 52 mg/L Cu and the copper loaded strip liquor averaged 60.8 g/L Cu and 2.0 g/L Ni.

Copper was successfully electrowon from the copper loaded strip liquor and the product contained >99.9% Cu.

The solvent extraction raffinate was processed through the cobalt recovery circuit in which hydrogen sulfide gas was sparged into the liquor. An average cobalt recovery of 98.5% was achieved in the cobalt recovery circuit. The cobalt product contained 27% Co.

Lithium recovery involved forced crystallisation of the cobalt precipitation filtrate. An intermediate containing 1.1% Li was recovered. This material was batch calcined to produce a lithium sulfate product containing 10% Li and predominantly present as lithium sulfate.

It will be understood that the invention disclosed and defined in this specification extends to all alternative combinations of two or more of the individual features mentioned or evident from the text or drawings. All of these different combinations constitute various alternative aspects of the invention.

1. A method of recovering metals from a leachate of an alkaline leach of electronic waste, the leachate comprising Cu, Li, and Mn ions, the method comprising:
recovering Mn from the leachate;
after the step of recovering Mn from the leachate, recovering Cu from the leachate; and
after the step of recovering Cu from the leachate, recovering Li from the leachate.

2. The method of claim 1, wherein the leachate additionally comprises Co ions, and after the step of recovering Cu from the leachate and prior to the step of recovering Li from the leachate, the method further comprises recovering Co from the leachate.

3. A method of recovering metals from a leachate of an alkaline leach of electronic waste, the leachate comprising Cu, Li, Ni, and Mn ions, the method comprising:
recovering Mn from the leachate;
after the step of recovering Mn from the leachate, recovering Cu and Ni from the leachate; and
after the step of recovering Cu and Ni from the leachate, recovering Li from the leachate.

4. The method of claim 2, wherein the leachate additionally comprises Co ions, and after the step of recovering Cu and Ni from the leachate and prior to the step of recovering Li from the leachate, the method further comprises recovering Co from the leachate.

5. The method of claim 1, wherein the step of recovering Mn from the leachate comprises:
treating the leachate with an oxidant to form a Mn precipitate, and
separating the Mn precipitate from the leachate.

6. The method of claim 5, wherein the oxidant is selected from a group consisting of air, hydrogen peroxide, and hypochlorite.

7. The method of claim 5, wherein the Mn precipitate is a manganese oxide selected from a group consisting of Mn₂O₃, Mn₃O₄, and MnO₂.

8. The method of claim 1, wherein the step of recovering Li from the leachate comprises:
crystallising ammonium lithium sulfate from the leachate, and
separating crystallised ammonium lithium sulfate from the leachate.

9. The method of claim 8, further comprising thermally decomposing the crystallised ammonium lithium sulfate to form a gas comprising ammonia and sulfur oxides, and solid lithium sulfate.

10. The method of claim 1, wherein the step of recovering Cu ions from the leachate uses a solvent extraction process, the solvent extraction process comprising:
contacting the leachate with an extractant to adsorb Cu ions into the extractant to form a Cu-loaded extractant, and
separating the Cu-loaded extractant from the leachate.

11. The method of claim 10, wherein the method further comprises stripping the Cu ions from the Cu-loaded extractant.

12. The method of claim 2, wherein the step of recovering Cu and Ni ions from the leachate comprises contemporaneously recovering Cu and Ni ions with a solvent extraction process, the solvent extraction process comprising:
contacting the leachate with an extractant to adsorb Cu and Ni ions into the extractant to form a Cu-, Ni-loaded extractant, and
separating the Cu-, Ni-loaded extractant from the leachate.

13. The method of claim 12, wherein the method further comprises stripping the Cu and Ni ions from the Cu-, Ni-loaded extractant using a stripping agent, wherein Ni ions are selectively recovered at a first stripping agent concentration and Cu ions are subsequently recovered at a second stripping agent concentration, the first stripping agent concentration being less than the second stripping agent concentration.

14. The method of claim 3, wherein prior to the step of recovering Cu the method further comprises treating the leachate with an oxidant to oxidise Co ions from Co²⁺ to Co³⁺.

15. The method of claim 4, wherein prior to the step of recovering Cu and Ni the method further comprises treating the leachate with an oxidant to oxidise Co ions from Co²⁺ to Co³⁺.

16. The method of any one of claims 2, wherein the step of recovering Co from the leachate comprises:
treating the leachate with a precipitant to form a Co precipitate; and
separating the Co precipitate from the leachate.

17. The method of claim 1, wherein the leachate comprises ammonium sulfate and ammonia.

18. The method of claim 1, wherein:
the leachate has an initial pH in the range of from about 8.5 up to 10.5; and/or
during one or more or each of the recovery steps the leachate has a pH in the range of from about 8.5 to 10.5.

19. The method of claim 1, wherein the leach solution comprises ammonia and ammonium sulfate in a ratio of from about 1:2 to about 1:20.

20. The method of claim 1, wherein:
the leachate has a Cu:Mn ratio of from about 0.5:1 up to about 2:1; or
the leachate has a Cu:(Mn+Co) ratio of from about 0.5:1 up to about 2:1; or
the leachate has a Cu:(Mn+Ni) ratio of from about 0.5:1 up to about 2:1; or
the leachate has a Cu:(Mn+Co+Ni) ratio of from about 0.5:1 up to about 2:1.
